(19) United States
(12) Patent Application Publication
(10) Pub. No.: US 2003/0135484 A1
(43) Pub. Date: Jul. 17, 2003

(54) Method for using services at a terminal and a terminal, a server and a program module therefore

(75) Inventor: Georg Gesek, Wampersdorf (AT)

Correspondence Address: SUGHRUE MION, PLLC, 2100 Pennsylvania Avenue, NW, Washington, DC, 20037-3213, US

(73) Assignee: ALCATEL

(21) Appl. No.: 10/340,692

(22) Filed: Jan. 13, 2003

(30) Foreign Application Priority Data
Jan. 14, 2002 (EP) 02 360 028.1

(51) Int. Cl. G06F 7/00

(52) U.S. Cl. 707/1

(57) ABSTRACT

The present invention relates to a method for using services (S1-S8) at a terminal (TER1, TER3) at which services can be called up via a user interface (UI) and also a terminal (TER1, TER3), a terminal module (PRMT), a server (PFS) and a server module (PRMS) for this.

In the method at least one user-specific preference (P1-P8) for a service (S1-S8) is detected and assigned to at least one request criterion (R1-R8) for the service (S1-S8). To call up the at least one service (S1-S8) an operating function (BF1-BF3) is offered on the user interface (UI) of the terminal (TER1, TER3) as a function of at least one situation-dependent parameter (PTI1-PTI4, PL1, PL2, PL2a). On activation of the operating function (BF1-BF3) the service (S1-S8) is called up on the user interface (UI) using the respective request criterion (R1-R8).

### BACKGROUND OF THE INVENTION

The invention is based on a priority application EP 02360028.1 which is hereby incorporated by reference.

The present invention relates to a method for using services at a terminal, at which services can be called up via a user interface, and also a terminal, a terminal module, a server and a server module therefore.

Services are increasingly being offered for users of terminals, in particular of communications terminals. For example, with a personal computer or a mobile telephone information can be called up from the internet or emails sent, shopping lists can be compiled or received or good sales offers communicated, non-cash payments can be made and other similar things. However, use of the wide variety of services is becoming increasingly difficult, if not altogether impossible in many cases, as users no longer have a clear view of the range of services. Even if users avail themselves of only a few services, they have to construct their own aids to make the services operable. For example, users can manually construct icons for the services they prefer on a graphic operating surface or a link list for an internet browser. However, this method is complicated and inconvenient for users.

In the field of so-called “electronic commerce” (e-commerce), in other words marketing of goods and services via the internet, there have already been some attempts to design the way goods are offered as user-specific. The web pages containing the respective range of goods are therein “tailor-made” in such a way that users are offered a range of goods arranged according to their main interests.

In WO 01/27782 A1 a method is described in which recommendations related to the person are provided for an internet browser of a user's terminal by a “personalisation server”. The browser sends user-specific information, in particular a user identifier identifying the user, to the server. Using these data and further information on the user already gathered previously, for example on web pages visited by the user, and thus possibly also preferred, recommendations are compiled and offered to the user. For example, links to recommended web pages, in other words request criteria for services, are compiled and communicated as a list to the internet browser in the user's terminal.

For reasons of data protection it is therein problematic that user-specific information is stored on the net, i.e. in the personalisation server. The recommendations are further based only on previous user behaviour, for example on web pages previously preferred by the user. The user's current needs or preferences in each case are not taken into account.

It is therefore the object of the invention to provide on request on a user interface of a terminal services optimally matched to the respective needs or preferences of the terminal user.

### SUMMARY OF THE INVENTION

The invention is based on the concept that one or more user-specific preferences for a service or several services are detected and in each case assigned to one or more request criteria for the respective service. For the preferences an operating function is offered on the user interface of the terminal as a function of at least one situation-dependent parameter. The situation-dependent parameter is, for example, time information on the current time in each case or place information on the current location of the terminal in each case. In any case, in offering the preferences account is taken of in what situation the terminal and thus its user is at the time, for example, at home in the morning, in a restaurant at midday, at a shopping centre at any time of the day, in the office in the afternoon or near a television set or suchlike in the afternoon or evening. The user can call up the service(s) by activating the operating function on the user interface. When calling up, the respective request criterion is used. A request criterion is, for example, a link to a web page, a start command for a program stored at the terminal and/or in a separate server operating the terminal, an access command to data stored at the terminal or in a separate memory device, e.g. a database, or similar. A request criterion can also contain selection criteria required for requesting data from a database.

The invention can advantageously be applied in internet portals, telecommunications services, payment services, banks, shopping centres or other service provision devices, where they make the respective services easier to operate. Access to the services by the terminal is also accelerated. Owing to simplified and accelerated access to the services, they are used more frequently. It is also possible that a service is used for the very first time on application of the invention, since it is offered on the user interface as a preference and/or is easier to operate.

The invention can be carried out, e.g. by a terminal configured according to the invention, on its own and/or in interaction with a server according to the invention, which is part of a telecommunications terminal, for example. For example, a telecommunications terminal, e.g. a mobile radio or fixed network terminal, a stationary or portable computer, e.g. a so-called personal computer or PDA (Portable Digital Assistant), video and audio apparatus or suchlike, by means of the invention can provide a convenient, user-orientated user interface.

It is possible, however, for, e.g., a known terminal or a conventional server to be equipped with a terminal module or server module according to the invention, i.e. with suitable software and/or hardware, so it can carry out the functions according to the invention. A server according to the invention can further provide the operating convenience according to the invention for a conventional terminal.

Further advantageous effects of the invention emerge from the dependent claims and the description.

As well as time information and/or place information on the current location of the terminal in each case, the situation-dependent parameter can also comprise other and/or further information, for example an identification signal locally receivable by the terminal as situation-dependent, e.g. a locally sent radio signal or GPS signal (Global Positioning System), an ambient noise locally logged by the terminal, light affecting the terminal, the respective ambient temperature at the terminal or suchlike. The respective situation of the terminal and thus indirectly also the respective situation of the user can already be clearly detectable by a single one of the previously mentioned parameters. It is also possible, however, that a combination of several of the previously mentioned parameters is evaluated by the terminal for this purpose.

Various possibilities can be considered for detecting the at least one user-specific preference: for example, the preference can be detected using a call-up command input on the user interface to call up the at least one service, e.g. use of one of or more internet links. Data requested at a separate server, for example, and/or data requested from a memory of the terminal can further be evaluated by the terminal. Key words, addresses or suchlike, for example, can therein be filtered out of the data. For example, it can be detected whether the data relate to a user's hobby and/or consumer goods preferred by him, e.g. a specific type of sport or specific food and drink. The frequency with which a service is called up is also advantageously suitable for determining the at least one user-specific preference. The terminal according to the invention and/or the server according to the invention, as it were, filter the call-up commands, requested data or suchlike to detect user-specific preferences.

It is particularly advantageous in relation to the later offering of operating function according to the respective user preference if, to detect the preference and/or in connection with detecting the at least one preference, the respective situation of the terminal during requesting or using the service is evaluated. For example, advantageously the respective time is detected at which a service is called up and/or the respective place at which a service is called up. If the terminal and thus the user is in a similar situation again, the terminal again, as it were, remembers the preferences of the user in the previous situation and offers an operating function on the user interface with which these preferences can be conveniently activated again. If, for example, in the evening the user often visits a web page where, for example, the evening television programmes are displayed, the terminal offers a link to this web page as “preference operating function” in the evening, whereas this link is not displayed during the day or is displayed at a lower-ranking position on the user interface.

This operating function can be offered in a wide variety of ways: for example, it can be activated via an operating button. The operating button can be, for example, a specific key on a keyboard of the terminal and/or a graphic representation of a button on a graphical user interface (GUI) of the terminal. Various preferences or request criteria for services which, as it were, “guide the user through life” can be linked to the operating button, depending on the situation of the terminal, in other words, e.g. time, place or other environmental conditions. By simply pressing the operating button the preference or the service chosen by the user in the respective situation is made available. An operating button of this kind could also be designated as a “life guide button”.

Some other operating symbol for activating the operating function can also be offered on a graphical user interface. The user interface can further contain a user menu for the operating function. On activation of the user menu the user interface shows, for example, a selection list from which the user's preferences can be selected.

The operating function is advantageously dynamic, i.e. it is updated as a function of the respective situation in which the terminal/user is located. For example, the most important preference in the respective situation is displayed at the top of a selection list.

A preference can be assigned to a single individual user profile of a single user of the user interface. It is also possible for the preference to be assigned to a higher-ranking user profile of the user interface, for example a general user profile assigned to at least two individual users. The preference can then be used for several individual users.

It has already been mentioned earlier that, for reasons of data protection, for example, it is problematic if user-specific information is stored on the net, e.g. in a personalisation server according to WO 01/27782 A1. It therefore already basically represents an original invention if in a method according to the preamble of claim 1 and in a corresponding terminal or terminal module according to the preambles of further independent claims the at least one preference and/or the at least one request criterion is stored in the terminal and/or on a storage medium which can be removed from the terminal, for example a flash memory card, a diskette, CD-Rom or suchlike. The terminal is then, as it were, self-sufficient, i.e. it can provide on request on the user interface of the terminal services optimally matched to the respective needs or preferences of the terminal user, independently of a telecommunications network

Naturally, variants of the invention, in which the at least one preference and/or the at least one request criterion is stored in one or more servers separate from the terminal, are also advantageous. There they can be requested by several terminals of one or more users. The preference or the at least one request criterion is then centrally available, for example, to several terminals of one user.

Depending on requirement, preference(s) or request criteria can also be partially stored in the terminal and partially in the server, wherein advantageously, for reasons of data protection, unproblematic data are stored centrally in the server, but data which need to be kept secret are stored locally in the terminal or the storage medium which can be removed from it.

In detecting the preference, the past is, of course, preferably considered, i.e. for example earlier user behaviour and/or a special liking for particular services, theme areas, preferred hobbies or suchlike, input individually by the user at the terminal. Advantageously a possible or probable future interest of the terminal user is also determined. Among other things, the at least one situation-dependent parameter is advantageously suitable for this. For example, a radio or infrared control signal is transmitted from a cash point device or payment device to the terminal and evaluated by the terminal as a situation-dependent parameter. Using the control signal, the terminal detects a probable preference, namely e.g. non-cash payment with the terminal and offers an appropriate operating function on the user interface.

The method according to the invention can in principle be applied locally at the terminal, for example for convenient, preference-orientated access to data stored in a memory of the terminal and/or for preference-orientated starting up and operating of service programs which can be carried out by the terminal, e.g. word processing, appointment planner or suchlike. Preferably, however, the invention enables preference-orientated access to one or more services provided via a communications network, in particular via the internet. The services are supplied, for example, by one or more servers of the communications network, e.g. so-called contents servers.

A communications connection with the help of which a service is supplied may in an individual case exist only between the terminal and a single device separate from this, for example the above-mentioned cashpoint device or payment device which is interactively operable by the terminal. It is also possible that within the scope of a service, for example, data are requested via the communications network from a server operating the terminal.

In the event of several preferences being detected for a user, the operating functions assigned to these are advantageously provided on the user interface, sorted according to a predetermined or dynamically detected sorting criterion. For example, if a first preference relates to payment for a product at a payment system and a second preference the display of products to be acquired on a display of the terminal. All the time the user of the terminal is still not in the vicinity of the payment system the products are displayed, while the operating function for paying is in the background of the user interface. As soon as the terminal is in the vicinity of the payment system, however, the products to be acquired are switched into the background and the operating function for payment is faded into the foreground of the display. Another variant is to display several preferences on the user interface in a kind of selection list, wherein a preference particularly liked by the user is displayed e.g. at the top of the list and less relevant preferences ranked behind and/or below the particularly liked preference.

### BRIEF DESCRIPTION OF THE DRAWINGS

The invention is illustrated below using embodiment examples with the aid of the figures.

FIG. 1 shows an arrangement with a terminal TER1 according to the invention, a conventional terminal TER3, a server PFS according to the invention and a service server CS.

FIG. 2 shows terminal TER1 according to FIG. 1 in a schematised detailed view.

FIG. 3 shows a user interface UI of terminal TER1 according to FIGS. 1 and 2.

FIG. 4 shows a schematised detailed view of the server PFS according to FIG. 1.

FIG. 5 shows a table TAB1 generated and/or used by terminal TER1 according to FIGS. 1 and 2 during application of the method according to the invention.

FIG. 6 shows a table TAB2 generated and/or used by the server PFS according to FIGS. 1 and 4 during application of the method according to the invention.

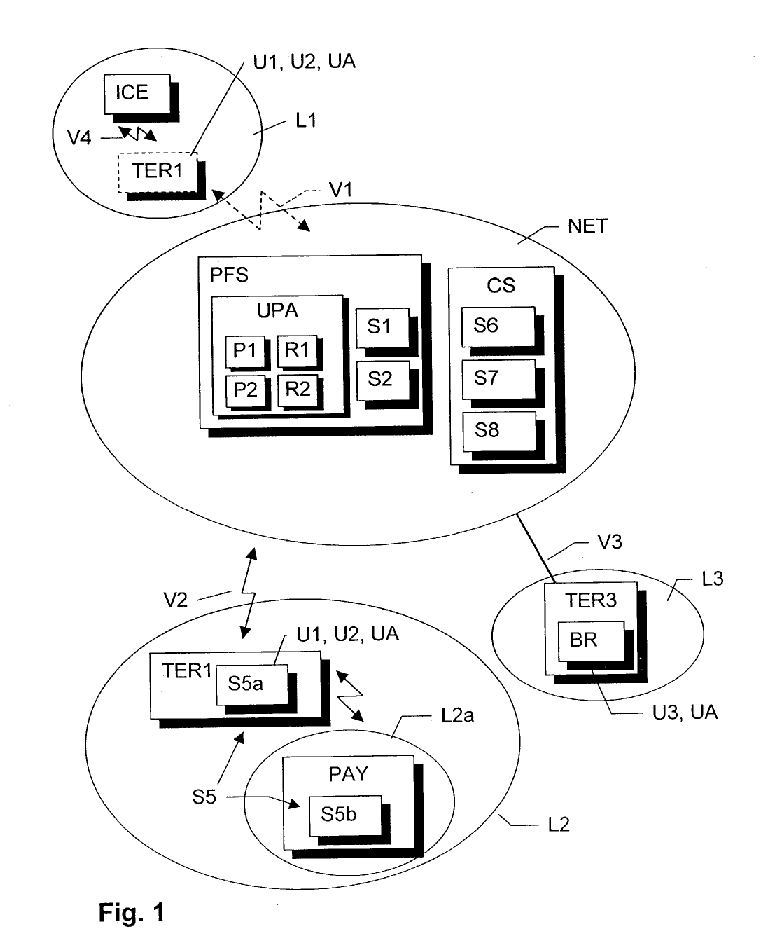

In FIG. 1 an arrangement with which the invention can be carried out is illustrated as an example. FIG. 1 shows terminals TER1 and TER3, which are connected or can be connected to a telecommunications network NET. The telecommunications network NET is or contains, for example, an Integrated Services Digital Network (ISDN) and/or a mobile radio network and/or a data network, e.g. the internet and/or a LAN (Local Area Network). The server PFS enables, in interaction with terminals TER1, TER3, user-orientated provision of services according to the invention on their respective user interface UI. The server PFS further offers terminals TER1, TER3 services S3, S4, which will be explained later. The service server CS provides services S6, S7, S8. As well as the server PFS and the service server CS, the telecommunications network NET can have further devices, not illustrated, for example relay centres, routers, switches or suchlike. As well as terminals TER1, TER3, the telecommunications network NET can also operate further terminals, not illustrated, or other telecommunications devices.

Terminals TER1, TER3 enable the use of services S1-S8, which can be called up on their respective user interface UI, wherein terminal TER1 is a terminal according to the invention and terminal TER3 is in the present case a conventional or at least largely conventional terminal. Terminals TER1, TER3 partially have identical components, which are correspondingly provided with the same names.

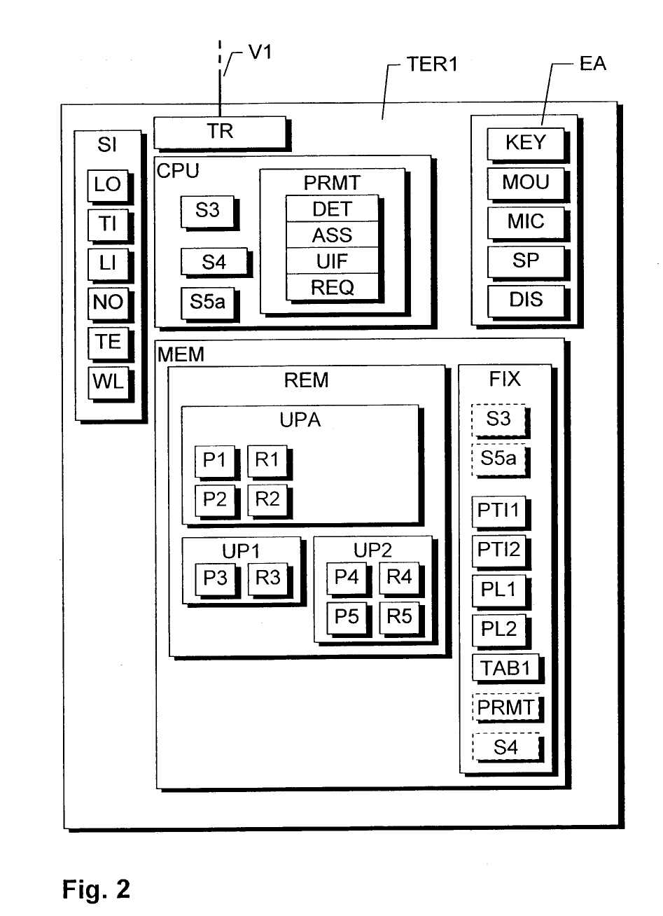

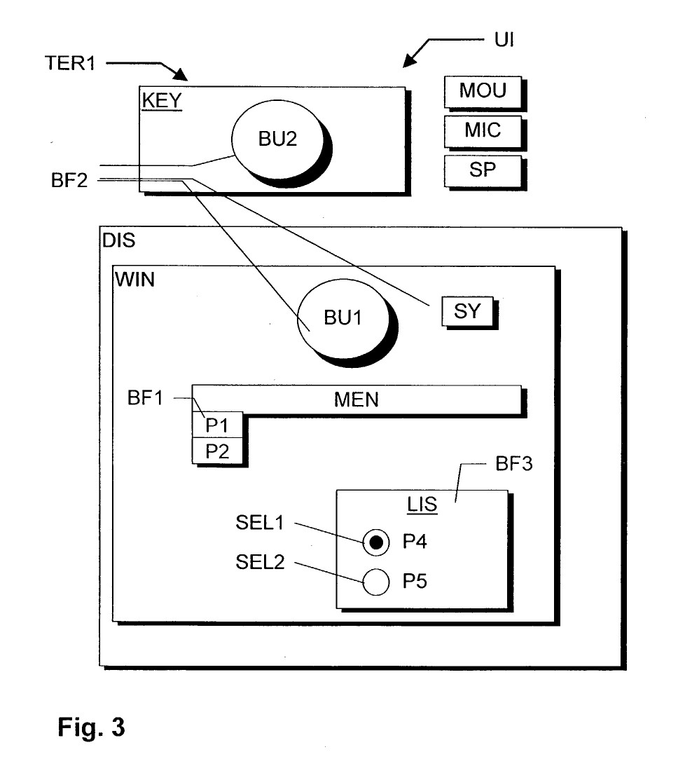

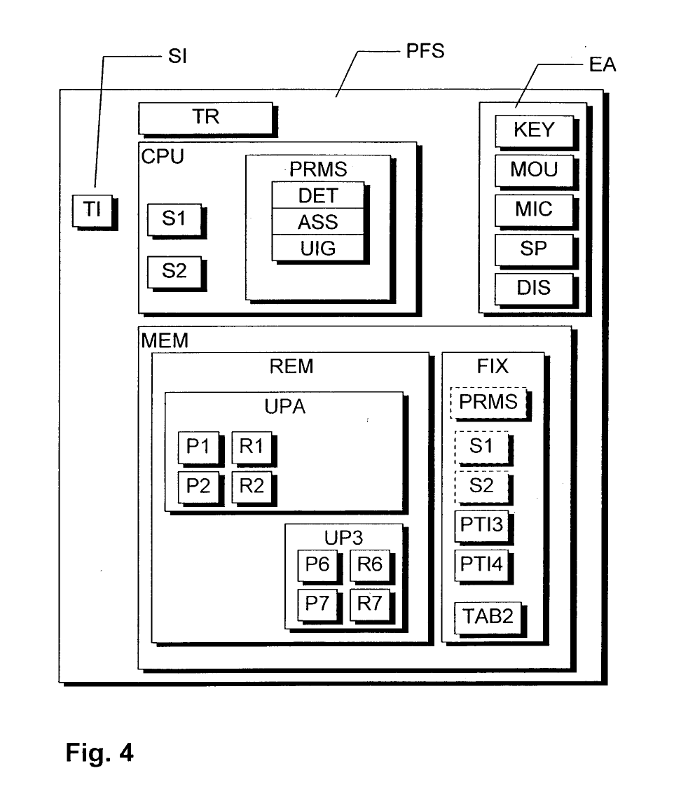

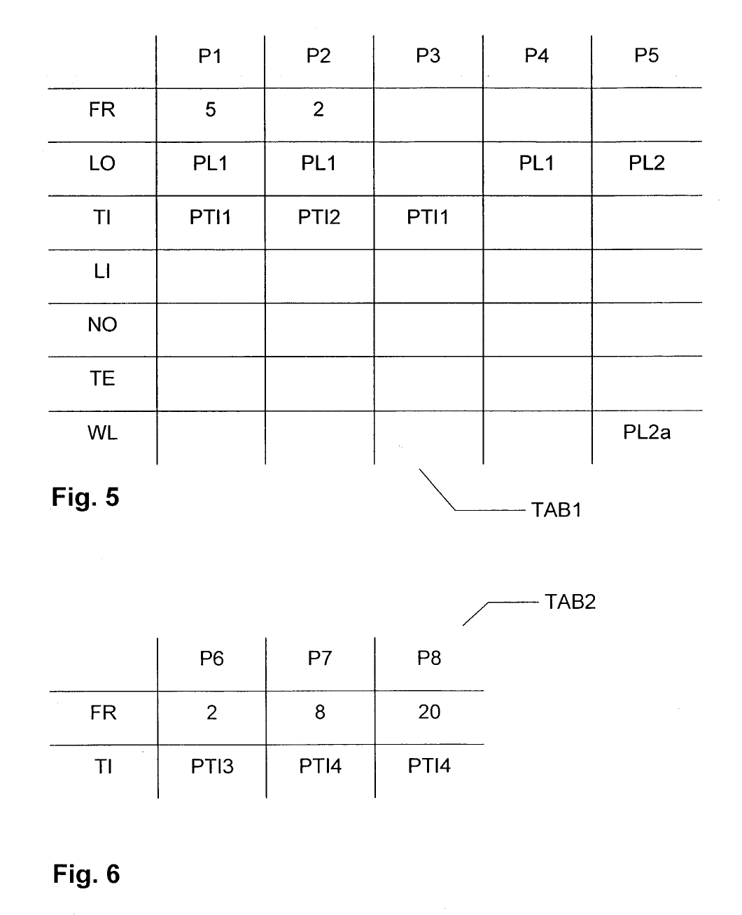

Terminal TER1 will first be explained below using FIG. 2. For convenient provision, user-orientated according to the invention, of services S1-S8 various means are provided at terminal TER1, including a terminal module PRMT according to the invention which contains a program code which can be carried out by a control means CPU, e.g. a processor arrangement of terminal TER1.

Terminal TER1 is, for example, a mobile radio or fixed network telephone suitable for connection to the internet or some other data network, a personal computer or suchlike. Terminal TER1 has a connecting means TR which contains, for example, a radio interface module, e.g. a GSM module (Global System for Mobile communication), an ethernet module, a modem, an ISDN adapter (ISDN=Integrated Services Digital Network), a DSL adapter (DSL=Digital Subscriber Line) or some other interface adapter for connecting to the telecommunications network NET. With the connection means TR the terminal TER1 can construct a connection V1 or V2, for example via a subscriber connection line or a radio connection, to the telecommunications network NET. Terminal TER1 further has a control means CPU and also memory means MEM. The control means CPU is, for example, a processor with which a program code of service program modules S3, S4, S5a, which are explained later, and of the terminal module PRMT can be carried out, which are stored in the memory means MEM (and) there can be called up by the control means CPU.

The memory means MEM are, for example, a hard disk, RAM components (RAM=Random Access Memory) or so-called Flash-ROM module (ROM=Read Only Memory). The memory means MEM contain in the present case both memory media REM, which can be removed from the terminal TER1, for example a diskette and/or a memory card with electronic memory, e.g. a so-called smart card or similar, and memory media FIX, which are installed as fixed in terminal TER1, e.g. a hard disk or similar.

Terminal TER1 further has input/output means EA, which contain as output means a display means DIS and a loudspeaker SP and as input means a microphone MIC for speech input, a keyboard KEY and a computer mouse MOU. The display means DIS is, for example, a computer monitor or an LCD display (Liquid Crystal Display).

Terminal TER1 further has logging means SI for logging one or more situation-dependent parameters. A timer TI logs time information PTI1, PTI2 on the current time in each case. A location logging device LO, for example a GPS receiver, logs place information PL1, PL2 on the current location L1, L2 of terminal TER1 in each case. A receiver WL, for example a bluetooth or infrared receiver, serves for situation-dependent local receiving of an identification signal PL2a. A noise meter NO detects a local ambient noise at terminal TER1. A light meter LI logs the respective lighting situation at terminal TER1. The light meter LI logs, e.g., light brightness affecting terminal TER1, for example whether it is day or night at the time, or, using the respective colour temperature, whether terminal TER1 is in a building or outdoors. A temperature meter TE logs the respective ambient temperature at terminal TER1.

Naturally, the logging means SI can also have other components for logging one or more situation-dependent parameters, for example a receiver for a time signal sent by a separate timer and/or only one single one of the aforementioned components may be present, e.g. the receiver WL.

The components of terminal TER1 are interconnected by internal connections, not illustrated.

From a functional point of view the server PFS in principle has a similar or identical structure to terminal TER1. The server PFS also contains control means CPU, memory means MEM, input/output means EA, connecting means TR and further components with the same names as terminal TER1, which in each case in principle carry out the same functions as the components of terminal TER1 of the same name. By contrast with terminal TER1, though, the logging means S1 of the server PFS contain only one timer TI or some other time logging device for logging time information PTI3, PTI4 on the current time in each case. Furthermore, instead of modules S3, S4, S5a, PRMT service program modules S1, S2 and a server module PRMS according to the invention are deposited in the memory means MEM of the server PFS. The control means CPU carries out the program code of service program modules S1, S2 and the server module PRMS.

Terminal TER3 could in principle have a similar or identical structure to terminal TER1. However, in the present case terminal TER3 is a conventional terminal, for example a personal computer or mobile radio terminal with which, e.g. telecommunications and/or data services can be used. Terminal TER3 has for this purpose, for example, a browser BR, e.g. a Microsoft Internet Explorer and/or a WAP browser (Wireless Application Protocol).

Terminal TER1 is used by users U1, U2 and also possibly by further users, also designated hereinafter as “general user UA”. Terminal TER1 is mobile and is used, e.g., at locations L1 and L2. In the drawings terminal TER1 is drawn in at both locations L1 and L2 for reasons of simplification, wherein, of course, in reality it can be at only one of locations L1 or L2. Therefore at location L1 terminal TER1 is drawn as a dotted line.

Terminal TER3 is stationary and connected to the telecommunications network NET via a connection V3. It is mainly used by one user U3, but partly also by the other users, e.g. the general user UA and/or users U1, U2.

In a first embodiment example execution of the invention is explained by means of terminal TER1. To make the invention easier to understand, a very simplified procedure is therein depicted. Naturally the invention brings even more advantageous effects if more complex methods are applied, for example so-called “artificial intelligence”.

A detection function DET of the terminal module PRMS first detects a user-specific preference P3 of user U1 for a service S3, e.g. an email program. User U1 starts up the email program, e.g. normally in the morning, to request his email mail box from a server, e.g. the server CS, as service S3. The detection function DET therefore asks for the time PTI1, for example, from the timer TI when service S3 is started up and enters this time PTI1 in table TAB1 as situation-dependent parameter.

In table TAB1 lines are provided in each case for the components of the logging means S1, namely the timer TI, the location logging device LO, the receiver WL, the noise meter NO, the light meter LI and the temperature meter TE, and columns for the preferences P1-P5. A further line FR is assigned to the frequency with which a service is used by user U1. The detection function DET could also enter in table TAB1, as well as the time PTI1, further situation-dependent parameters in connection with preference P3, for example at what location service S3 is activated, e.g. at the office, at home or suchlike.

An assigning function ASS of the terminal module PRMS assigns preference P3 to a request criterion RS for service S3. Request criterion R3 contains, for example, a start command and/or a logical link to service S3, with which in the present case the appropriate email program can be started.

An offering function UIF of the terminal module PRMS offers an operating function BF2 for preference P3 for calling up service S3 on the user interface UI as a function of situation-dependent parameter PTI1. The offering function UIF detects as a function of one or more situation-dependent parameters, in the present case parameter PTI1, the respective preference of user U1 for a service, in the present case service S3, preferred by user U1 at the time of day according to parameter PTI1. Via operating function BF2 user U1 can conveniently activate service S3. Operating function BF2 can, for example, be activated via a key BU2 on the keyboard KEY and/or a graphic representation BU1 of a key or a symbol SY in the window WIN. Key BU2 can be a key permanently assigned to an operating function according to the invention or a so-called soft key, in other words a key to which a function can be dynamically assigned, e.g. depending on the context.

The user interface UI is, for example, a graphic user interface which displays a window WIN on the display means DIS and can receive the input commands e.g. from the keyboard KEY and/or the mouse MOU. The user interface UI is, for example, part of an operating system for terminal TER1 and/or part of an application program which can be carried out by terminal TER1, e.g. an internet browser, for example a Microsoft Internet Explorer or a Netscape Navigator.

Pressing key BU2 and/or activating the graphic representation BU1 or the symbol SY with the mouse MOU, in other words activation of operating function BF2, is logged by the offering function UIF and/or a request function REQ of the terminal module PRMS. The request function REQ then calls up service S3 with the aid of request criterion R3. It starts, for example, the email program representing service S3.

If the offering function UIF detects that parameter PTI1 has not been complied with, i.e. if it is afternoon or night, for example, it does not provide operating function BF2 on the user interface UI and/or it assigns a preference for another service to operating function BF2. For example, it can assign to operating function BF2 in the evening a request typically made by user U1 from the server CS for the evening television programmes. Several preferences can therein also be assigned to operating function BF2, for example different requests for television programmes preferred by user U1, e.g. detective series or entertainment broadcasts. If user U1 presses key BU2 in the evening, the terminal module PRMS or terminal TER1 then ar any rate does not start up service S3, but sends a request for the evening television programmes to server CS. Preference P3 and request criterion R3 are deposited in a user profile UP1, assigned to user U1. To activate user profile UP1 user U1 must log on at terminal TER1, for example by input of a password, a finger print, speech identifier or suchlike.

The detection function DET, the assignment function ASS, the offering function UIF and the request function REQ are, for example, subordinate functions, routines or other program parts of the terminal module PRMS. Naturally, other functional divisions of the terminal module PRMS are also possible. The terminal module PRMS can, for example, also be a user interface module provided with the above-mentioned functions DET, ASS UIF, REQ, for example a user interface of an operating system of terminal TER1, a browser or similar. The user interface module provides, e.g., the user interface UI.

A further user profile UP2 of terminal TER1 is assigned to user U2. User U2 can activate user profile UP2 by logging on at terminal TER1. User profile UP2 contains preferences P4 and P5 of user U2 for services S4 and S5 and request criteria R4 and R5 assigned to these services.

Service S4 is, for example, a database program displaying the respective requirement of user U2 for goods to be acquired. User U2 can enter the goods to be acquired, e.g. food, clothing, consumer goods or suchlike, into a list provided by service S4. It is also possible for the service to cooperate with a stocking up device of user U2, for example an intelligent refrigerator ICE at location L1, the home of user U2. The refrigerator ICE communicates the food to be acquired, e.g. via the telecommunications network NET and/or via a radio or infrared connection V4, locally at location L1 to service S4.

If user U2 moves with terminal TER1 from location L1, his home, to a location L2, e.g. a shopping centre, this is detected by terminal TER1, more precisely by the terminal module PRMT. For example, the location logging device LO at location L1 sends place information PL1 and at location L2 place information PL2 to the terminal module PRMT. At location L2, the shopping centre, the terminal module PRMT receives place information PL2 and correspondingly in window WIN of the user interface UI fades in operating function BF3, which in the present case contains a selection list LIS for preferences P4 and P5.

On activating one of the areas SEL1 assigned to preference P4, e.g. by clicking the mouse MOU, the terminal module PRMT starts service S4, i.e. the list with food to be acquired is displayed on the user interface UI. Assigning preference P4 to place information PL2 has been detected by the terminal module PRMT, e.g. on an earlier visit to the shopping centre L2 by user U2 and entered in table TAB2.

When user U2 has made his purchases and correspondingly proceeds with his terminal TER1 into the vicinity of a payment device PAY in the shopping centre L2, the receiver WL receives from the payment device PAY, e.g. by radio, a local identification signal PL2a and communicates this to the terminal module PRMT. The terminal module PRMT recognises from the identification signal PL2a that user U2 will probably now prefer service S5 and correspondingly places preference P5 at the top of the selection list LIS (not illustrated in the figure). The selection list LIS is, as it were, re-sorted. On activating an operating area SEL2 assigned to preference P5, e.g. by clicking the mouse MOU, the terminal module PRMT starts up service S5.

Service S5 is an interactive payment service in which a service program S5a of terminal TER1 interacts with a service program S5b of the payment device PAY. For example, service program S5a sends to service program S5b a list of the goods purchased and service program S5b thereupon sends service program S5a the purchase price to be paid for them. The subsequent, preferably non-cash, payment is also interactively transacted by service programs S5a, S5b.

Naturally, operating function BF3 can also contain further preferences, not illustrated, for non-illustrated services. For example, a preference to fade in a list of special offers at location L2 can be included. On activation of an operating area assigned to this preference, terminal TER1 sends, for example, a request to a service computer of the shopping centre which responds with a list of special offers. Communication can take place, e.g. by SMS (SMS=Short Message System).

In other situations, e.g. at a different location, a preference for a different service can be displayed in the selection list LIS. For example, a preference for a predetermined internet address can be indicated in the list LIS at location L1.

Naturally, preferences P4, P5 could also be assigned, for example, to a single operating button, e.g. the “life guide button” mentioned. By pressing the operating button in the vicinity of the payment device PAY, service S5, for example, is started up, or otherwise service S4.

In a further embodiment example functions according to the invention are supplied by the server PFS and the server module PRMS.

User profile UPA stored in the server PFS is a general user profile assigned, for example, to users U1 to U3. User profile UPA is detected and constructed by the server module PRMS. User profile UPA contains preferences P1 and P2 for services S1, S2, for example for specific web pages or suchlike which are visited by users U1 to U3 frequently and/or in typical situations, e.g. always from location L1 (=parameter PL1) and/or at times PTI1, PT2. Values “5”, “2” and “20”, for example, are entered in table TAB1 for preferences P1, P2 for the frequency FR, parameters PL1 for the location LO and parameters PTI1, PT2 for the time TI. Request criteria R1 and R2 for services S1, S2, for example links to web pages, are assigned to preferences P1 and P2.

The server module PRMS, like the terminal module PRMT, contains a detection function DET and an assignment function ASS, which in principle perform the same functions as the functions of the same names of the terminal module PRMT. Situation-dependent parameters can be partially detected by the server PFS itself, for example a current time, and partially requested at the respective terminal, for example its current location.

Instead of the offering function UIF and the request function REQ, in the server module PRMS an instruction function UIG is provided, which sends instructions to terminals TER1, TER3, using which these terminals TER1, TER3 can offer an operating function BF1, provided for calling up services S1, S2, for preferences P1, P2 on the user interface UI as a function of situation-dependent parameters PTI1, PTI2, PL1 and in the present case additionally as a function of the frequency FR. The instructions are, for example, HTML data (HTML=HyperText Markup Language) for displaying preferences P1, P2 as so-called hyperlinks on the user interface UI.

In the present case, however, a menu bar MEN of the user interface UI forms the operating function BF1. The menu bar MEN is modified according to the instructions of the instruction function UIG. For example, at time PT1 the instruction function UIG sends instructions to terminal TER1 to the effect that preference P1 is displayed as top/first preference on the menu bar MEN, but at time PT2 instructions to the effect that preference P2 is displayed as top/first preference on the menu bar MEN (not illustrated in the figure). On activation of menu areas SEL3, SEL4, assigned to preferences P1, P2, services S1, S2 are activated by means of request criteria R1, R2, e.g. appropriate web pages are displayed on the user interface UI.

User profile UPA is in this case stored centrally at the server PFS and additionally locally at terminal TER1. Accordingly, operating function BF1 can be both offered locally by terminal TER1 independently of the server PFS and requested by terminal TER3 from the server PFS. In other words the conventional terminal TER3, e.g. a personal computer, can also use a service according to the invention. For this purpose, for example, a web page with which the server module PRMS can be addressed via a hyperlink is called up via a browser. The server module PRMS then sends, e.g. HTML data for displaying preferences P1, P2 to the browser as so-called hyperlinks.

User profiles UP1, UP2, UPA are stored in the removable memory medium REM. The memory medium REM can be removed from terminal TER1 and inserted in another terminal, for example terminal TER3. The respective terminal can there read out user profiles UP1, UP2, UPA and provide the functions according to the invention explained above.

The general user profile UPA comprises, for example, non-critical data, for which relatively low data protection requirements have to be met. It is different with a personal user profile UP3 for user U3 which is also stored in the server PFS and which is constructed by the server module PRMS using at least one situation-dependent parameter. User profile UP3 contains preferences P6, P7 and P8 for services S6, S7 and S8, which the server CS supplies for the terminal TER and which can be requested from it by means of request criteria R6, R7, R8. The data of user profile UP3 are secured against unauthorised access in the server PFS by means of suitable access security, e.g. by password.

Service S6 is preferred by user U3, for example, at a time or in a time range PT3 and services S7 and S8, for example, at a time or in a time range PT4. Appropriate values are entered in table TAB2 for preferences P6, P7, P8. Values “2”, “8” and “20” are further entered for frequency of use FR of preferences P6, P7, P8 or services S6, S7, S8 at times PT3, PT4.

If user U3, e.g. with terminal TER1 or TER3, requests user profile UP3 from server module PRMS at time PT3, e.g. at 8 o'clock in the morning, it sends, for example, instructions to the effect that only one operating function is displayed for activating preference P6 or service S6 on the user interface UI of terminal TER1, TER3. If the user activates this operating function, request criterion R6, for example, is sent to the server CS, whereupon it provides service S6. Service S6 relates, for example, to the display of current delays in public transport at terminal TER1, TER3.

If, on the other hand, user U3 requests user profile UP3 at time PT4, e.g. at 10 o'clock in the morning, the server module PRMS sends, for example, instructions to the effect that a selection list with preferences P7, P8 is displayed on the user interface UI of terminal TER1 or TER3. Preference P8 is therein in the foreground and/or at the top of the list, as its value for frequency of use FR is higher and service S8 assigned to it is consequently used more frequently by user U3 than service S7. Service S8 relates, for example, to a telephone or address book function and service S7 to the display of current stock market rates at terminal TER1, TER3.

1. Method for using services at a terminal, at which services can be called up via a user interface, wherein the following steps are performed:
detecting at least one user-specific preference for a service,
assigning the at least one preference to at least one request criterion for the at least one service,
wherein by the steps:
offering an operating function for the at least one preference for calling up the at least one service on the user interface as a function of at least one situation-dependent parameter and
on activation of the operating function calling up the at least one service on the user interface using the at least one request criterion.

2. Method according to claim 1, wherein the at least one situation-dependent parameter comprises time information on the current time in each case and/or place information on the current location of the terminal in each case and/or an identification signal locally receivable by the terminal as situation-dependent and/or an ambient noise at the terminal and/or light affecting the terminal and/or an ambient temperature at the terminal.

3. Method according to claim 1, wherein the at least one preference is detected using a call up command input on the user interface for calling up the at least one service and/or using data requested by the terminal and/or using the frequency with which the at least one service is called up.

4. Method according to claim 1, wherein to detect the at least one preference and/or in connection with detecting the at least one preference the respective situation of the terminal during requesting or use of the service is detected, wherein in particular at least one time at which the at least one service is called up and/or at least one location at which the at least one service is called up is detected.

5. Method according to claim 1, wherein the operating function can be activated via an operating button and/or an operating symbol and/or a user menu and/or a selection list.

6. Method according to claim 1, wherein the at least one preference is assigned to an individual user profile of a single user of the user interface and/or to a higher ranking user profile of the user interface, assigned to at least two individual users.

7. Method according to claim 1, wherein the at least one preference and/or the at least one request criterion is stored in the terminal and/or on a memory medium removable from the terminal and/or a server, from which the at least one preference or the at least one request criterion can be requested by the terminal.

8. Method according to claim 1, wherein, using the at least one preference and/or using the at least one situation-dependent parameter, a future preference which a user of the terminal will probably have is detected.

9. Method according to claim 1, wherein the at least one service is provided via a communications network, in particular via the internet.

10. Method according to claim 1, wherein the at least one service comprises interactive operation of a device separate from the terminal, in particular a payment system and/or the requesting of data from a memory of the terminal and/or requesting of data from a server operating the terminal.

11. Method according to claim 1, wherein a first and at least one second preference assigned to a first and at least one second service is logged, the first preference is assigned to a first request criterion for the respective service and the at least one second preference is assigned to at least one second request criterion for the respective service and the operating function for calling up the respective service on the user interface provides the first and the at least one second preference, sorted according to a predetermined or dynamically detected sorting criterion, on the user interface.

12. Terminal for using services at which services can be called up via a user interface, with means for carrying out the steps:
detecting at least one user-specific preference for a service,
assigning the at least one preference to at least one request criterion for the at least one service,
offering an operating function for the at least one preference for calling up the at least one service on the user interface as a function of at least one situation-dependent parameter and
on activation of the operating function calling up the at least one service on the user interface using the at least one request criterion.

13. Terminal module for using services at a terminal, at which services can be called up via a user interface, wherein the terminal module contains a program code which can be carried out by control means of the terminal, wherein this terminal carries out the following functions:
detecting at least one user-specific preference for a service,
assigning the at least one preference to at least one request criterion for the at least one service,
offering an operating function for the at least one preference for calling up the at least one service on the user interface as a function of at least one situation-dependent parameter and
on activation of the operating function calling up the at least one service on the user interface using the at least one request criterion.

14. Server for using services at a terminal which has a user interface for calling up the services, with means for providing the services on the user interface in interaction with the terminal, wherein the means are configured for carrying out the following steps:
detecting at least one user-specific preference for a service,
assigning the at least one preference to at least one request criterion for the at least one service,
sending instructions to the terminal using which the terminal can offer an operating function provided for calling up the at least one service for the at least one preference on the user interface as a function of at least one situation-dependent parameter.

15. Server according to claim 14, wherein the means are configured for detecting the preference and/or for sending the instructions for the operating function as a function of at least one situation-dependent parameter, in particular time information on the current time in each case and/or place information on the current location of the terminal in each case.

16. Server module for using services at a terminal at which services can be called up via a user interface, wherein the server module contains a program code which can be carried out by control means of the server, so the server carries out the following functions in interaction with the terminal:
detecting at least one user-specific preference for a service,
assigning the at least one preference to at least one request criterion for the at least one service,
sending instructions to the terminal using which the terminal can offer an operating function provided for calling up the at least one service for the at least one preference on the user interface as a function of at least one situation-dependent parameter.

17. Memory means, in particular diskette or CD-ROM, Digital Versatile Disc, hard disk drive or similar, with a terminal module according to claim 13 stored on it and/or with a server module according to claim 16 stored on it.
